(19) United States
(12) Patent Application Publication
(10) Pub. No.: US 2006/0059306 A1
(43) Pub. Date: Mar. 16, 2006

(54) Apparatus, system, and method for integrity-assured online raid set expansion

(76) Inventor: Charlie Tseng, San Jose, CA (US)

Correspondence Address: KUNZLER & ASSOCIATES, 8 EAST BROADWAY, SALT LAKE CITY, UT, 84111, US

(21) Appl. No.: 10/940,699

(22) Filed: Sep. 14, 2004

(51) Int. Cl. G06F 12/00

(52) U.S. Cl. 711/114; 711/170

(57) ABSTRACT

An apparatus, system, and method are disclosed for online RAID set expansion from an amount of disks i to an amount of disks j, where j disks includes one or more new disks, with data integrity assurance during the expansion process. In accordance with the invention, data migration to the destination RAID set comprises segments with a variable length, such that a sub-stripe group of a certain size is included in each segment migrating within an identified destructive zone (“DZ”) thereof, avoiding overwriting of any corresponding source data. Thus, the invention eliminates a requirement for data backup before migration to the DZ to protect against data loss due to a possible power failure. Beyond the DZ, data migration is allowed to proceed in segments with a different length, such as allowing a whole stripe group to migrate safely, so as to achieve a normally possible maximum efficiency.

### BACKGROUND OF THE INVENTION

1. Field of the Invention

This invention relates to data space management of a storage system and more particularly relates to online expansion of a Redundant Array of Independent Disks (“RAID”) set to acquire more data space with data integrity assurance.

2. Description of the Related Art

In a contemporary computing system, a host is connected to a storage system via a storage controller through an interface such as a Peripheral Component Interconnect (PCI) bus. The storage controller is coupled to a plurality of storage devices selected from contemporary hard disk drives such as Serial Attached SCSI (“SAS”) disk drives, Serial Advanced Technology Attachment (“SATA”) disk drives, and Fibre Channel disk drives. Furthermore, the storage devices may be of another type such as optical disks, magneto-optical disks, solid state disks, magnetic tape drives, DVD disks, and CD-ROM disks. Of whatever type, the storage devices hereinafter are referred to as disks.

Frequently, the disks coupled to the storage controller form a Redundant Array of Independent Disks (“RAID”) set, which is a striped disk array. Striping is a method of concatenating multiple disks into one logical drive. Striping involves partitioning each disk's storage space into stripes, each of which is a number of consecutively addressed blocks. These stripes are then interleaved such as in a round robin interleaving, so that the combined space of the logical drive is composed alternately of stripes from each member disk of the array. In FIG. 1a one embodiment of a three-disk RAID set 30 is illustrated. During RAID data creation, striping refers to the storing of sequential blocks of incoming data combined into separate stripes across the three disks: disk1 21, disk2 22, and disk3 23 in a regular rotating pattern. Eighteen (18) data stripes labeled with consecutive hexadecimal numbers from 0, 1 . . . to 10, and 11 are shown in the RAID set 30. The eighteen (18) data stripes are subdivided into six (6) stripe groups, each of which includes one data stripe from each of the three member disks 21, 22, and 23 of the RAID set 30. Stripe group 0, for example, includes data stripes numbered 0, 1 and 2, residing on disk1 21, disk2 22, and disk3 23, respectively.

The host writes data to, and reads data from, the disks of the RAID set through the storage controller. The storage controller writes data to the disks according to a user-selected RAID level providing a certain level of redundancy. Various RAID levels have been used in storage systems in the industry. For example, RAID 0 is known as a non-redundant RAID array, RAID 4 and RAID 5 are referred to as parity RAID arrays, and RAID 0+1 (also known as RAID 6) is called a mirrored RAID array. In general, each of the RAID levels may be implemented with a variable number of disks, although in some cases, there is a relationship between the RAID level and the number of disks, such as a minimal number of disks required by a particular RAID level: two disks by RAID 0 and three disks by any of the other said RAID levels. As is commonly known in the art, for some computing systems, online dynamic expansion to add one or more disks to the existing RAID set is required as host storage demands increase.

One requirement imposed on an online RAID set expansion process is assurance of data integrity during data migration from an existing RAID set, referred to as a source RAID set, to an expanded RAID set, referred to as a destination RAID set. Although intrinsically the level of data integrity is high in a RAID set, a power failure during the expansion process may cause data loss. In current approaches to such an expansion process, multiple stripes of data are streamed from a source RAID set into an assumed empty larger destination RAID set with all disks participating in parallel concurrently, which is a typical mode of operation for transferring incoming data to a RAID set for high efficiency. Consequently, one or more data stripes arriving in the destination RAID set is liable to suffer data loss in the event of a power loss because source data stripes are being overwritten as a result of the data migration. In such a power loss case, after the power is restored, if the source data is no longer completely available for re-migration, the affected data stripes have lost data. In general terms, the stripe groups in the destination RAID set each including data stripes that may be lost or losable constitute a destructive zone (“DZ”).

To demonstrate a destructive zone exposure, FIGS. 1a-1e are block diagrams illustrating aspects of an exemplary online expansion process 20 of one embodiment of a non-redundant RAID set of the current practice. With reference to Example 1 in FIG. 1a through FIG. 1e, a current storage system expands a three-disk RAID set 30 including eighteen (18) consecutively numbered data stripes to a four-disk RAID set 40 by migrating four data stripes consisting of copying data thereof to each stripe group of the destination RAID set 40 in parallel concurrently. FIG. 1a shows an assumed initial configuration of the destination RAID set 40 prior to data migration even though data stripes number 0, 1, and 2 are already in the proper positions in stripe group 0 therein.

During migration step 1 as depicted in FIG. 1b, data stripes number 0, 1, 2 and 3 are being migrated at the same time from the source RAID set 30 to the destination RAID set 40 stripe group 0 on disks 1, 2, 3, and 4 21, 22, 23, and 24, respectively. Data stripes number 0, 1, and 2 are partially losable in case of a power failure occurring in the midst of the migration because of the overwriting of the source data on disks 0,1 and 2 21, 22, and 23, respectively. Likewise, data stripes number 4, and 5 in stripe group 1, and data stripe number 8 in stripe group 2, of the destination RAID set 40 are subject to data loss in case of a power outage, as illustrated in FIG. 1c and FIG. 1d, respectively. The DZ in the destination RAID set 40 includes stripe groups 0, 1, and 2, as shown in FIG. 1d. In FIG. 1e, data stripes number C, D, E, and F are being concurrently migrated in migration step 4 to stripe group 3 in the destination RAID set 40 without being in danger of suffering a data loss due to a power failure because none of the corresponding source data can be overwritten. Beyond the DZ, data may be safely streamed from the source RAID set 30 into the destination RAID set 40 one stripe group at a time.

Currently, data due to migrate to the DZ is backed up on an added disk before migration. Since in some cases, only one disk may be added for a RAID set expansion, the pre-backed up DZ data is not protected against a possible failure of the added disk. Current approaches, therefore, call for backing up the data that will be subject to the destructive zone exposure on both the existing disks and the added disk(s) and providing fault tolerance such as data mirroring in some unused disk space. Unfortunately, if there is inadequate unused disk space available on said disks, the host command requiring a RAID set expansion process will be rejected.

From the foregoing discussion, it should be apparent that a need exists for an apparatus, system, and method that avoids any destructive zone exposure to a possible power failure leading to data loss, without requiring any kind of data backup before migration. Beneficially, such an apparatus, system, and method would allow data migration beyond the DZ to be conducted with a maximum efficiency as normally achievable with a RAID set.

### SUMMARY OF THE INVENTION

The present invention has been developed in response to the present state of the art, and in particular, in response to the problems and needs in the art that have not yet been fully solved by currently available storage controllers. Accordingly, the present invention has been developed to provide an apparatus, system, and method for online expansion RAID set with data integrity assurance that overcome many or all of the above-discussed shortcomings in the art.

The apparatus to perform online RAID set expansion by adding at least one disk is provided with a logic unit containing a plurality of modules configured to functionally execute the necessary steps of integrity-assured online expansion. These modules in the described embodiments include an expansion registration module, a safety direction module, a service module, a watermark setting module, and a segment selection module.

The expansion registration module registers a RAID set expansion process in response to a host command and de-registers the RAID set expansion process subsequent to completion of the expansion process. The expansion process is configured to migrate consecutive data stripes in an ascending numerical order from a source RAID set to a plurality of stripe groups in a destination RAID set in segments each consisting of one or more data stripes, including re-striping within the group as if the destination RAID set had been originally configured by the user. The destination RAID set has at least one more disk than the source RAID set.

The safety direction module determines the number of stripe groups beginning with the first stripe group (number 0) in the DZ in the destination RAID set based on pre-specified selection criteria. As mentioned previously, the DZ includes some data stripes that would be subject to data loss in case of a power failure because corresponding source data stripes were being overwritten resulting from the data migration had the data migration been conducted as done in the prior art. The safety direction module may segment each stripe group in the DZ into a plurality of subgroups and set a safe length of each segment migrating within the DZ as including a subgroup which may contain, for example, one data stripe per segment, to avoid overwriting of source data during migration. The safety direction module may set the length of segment migrating beyond the DZ as including a whole stripe group, as done in the prior art, because source data overwriting is no longer possible during migration. In certain embodiments, the sub-stripe group may include more than one data stripe, with the maximum number being equal to the number of disks added for expansion.

The watermark setting module is initialized to identify the highest numbered data stripe in the first stripe group of the destination RAID set existing on one original disk before expansion and is configured to identify the highest numbered data stripe in each segment after data migration. The segment selection module selects the segment next in line to migrate based on the watermark and is configured to identify the last segment to migrate. Thus, the segment selection module addresses the data stripe numbered higher than what is identified by the watermark by one (1). The service module performs the expansion process on each selected segment by copying data thereof from the source RAID set onto the destination RAID set.

In one embodiment, the apparatus includes an Input/Output (“I/O”) module. The I/O module may receive an I/O command to read or write data. The I/O command comprises a data block address which can be mapped to a data stripe, referred to herein as an associated data stripe, identifying where the data is to be read from or written to. If an expansion process is not active, the I/O module accesses the data block as usual. If an expansion process is active, the I/O module determines if the associated data stripe along with any stripe group check data is in transit for migration. If not so, the I/O module accesses the data block. If any part of the data stripe along with any stripe group check data is in transit for migration, the I/O module delays accessing the data block.

A system of the present invention is also presented for the integrity-assured online RAID set expansion. The system in the disclosed embodiments includes a host, a plurality of disks, and a storage controller comprising a processor, a memory coupled to the processor, a non-volatile memory coupled to the processor, a host interface coupling the storage controller to the host, an expansion registration module, a safety direction module, a watermark setting module, a segment selection module, and a service module. In one embodiment, the system includes an I/O module.

The expansion registration module registers an expansion process in response to a host command and de-registers the expansion process subsequent to the completion of the expansion process. The safety direction module identifies the number of stripe groups in the DZ in the destination RAID set and sets a safe length of each segment to migrate both within the DZ to avoid overwriting of source data and beyond the DZ. The watermark setting module is initialized to identify data already in the first stripe group of the destination RAID set before expansion and sets a watermark identifying data migrated for each segment. The segment selection module addresses the data next to migrate in the segment based on the watermark. The service module performs an expansion process on each segment selected by copying data thereof from the source RAID set to the destination RAID set. In certain embodiments, the watermark is stored in the non-volatile memory. The I/O module manages I/O operations in concurrency with an online RAID set expansion process.

A method of the present invention is also presented for the integrity-assured online RAID set expansion. The method in the disclosed embodiments substantially includes the steps necessary to carry out the functions presented above with respect to the operation of the described apparatus and system. In one embodiment, the method includes registering an expansion process, identifying the number of stripe groups in the DZ, initializing a watermark, selecting a segment next to migrate based on the watermark, setting the length of the segment next to migrate according to the destination position, performing an expansion process on each selected segment by copying data thereof from the source RAID set onto the destination RAID set, setting a watermark identifying the highest numbered data stripe in the segment migrated, and de-registering the expansion process upon completion.

The expansion registration module registers the expansion process. The safety direction module identifies the number of stripe group in the DZ. The watermark setting module initializes the watermark before the expansion begins and sets a watermark after each segment is migrated. The segment selection module selects the segment next to migrate based on the watermark. The safety direction module sets a safe length of each segment to migrate, depending on whether the segment is destined within the DZ or thereafter. The service module performs the expansion process on each segment selected by the segment selection module with the length indicated by the safety direction module. The expansion registration module de-registers the expansion process upon completion as determined by the segment selection module.

In one embodiment, the I/O module receives an I/O command to read or write data. The I/O command comprises a data block address which can be mapped to a data stripe identifying where the data is to be read from or written to. If an expansion process is not active, the I/O module accesses the data block as usual. If an expansion process is active, the I/O module determines if the associated data stripe along with any stripe group check data is in transit for migration. If the associated data stripe or any stripe group check data is not in transit, the I/O module accesses the data block. If any part of the data stripe along with any stripe group check data is in transit for migration, the I/O module delays accessing the data block.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

The present invention determines a safe length for each segment migrating to the DZ during RAID set expansion, avoiding any loss of data due to a possible power failure without requiring a backup of any data prior to migration. In addition, the present invention allows data migration in segments to proceed beyond the DZ with a different length so as to achieve a maximum efficiency, as possible in the prior art. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIGS. 1a-1e are schematic block diagrams illustrating aspects of an exemplary expansion process of one embodiment of a non-redundant RAID set of the current practice;

FIG. 2 is a schematic block diagram illustrating one embodiment of an online RAID set expansion system in accordance with the present invention;

FIG. 3 is a schematic block diagram illustrating one embodiment of an online RAID set expansion apparatus in accordance with the present invention;

FIG. 4 is a schematic flow chart diagram illustrating one embodiment of an online RAID set expansion method in accordance with the present invention;

FIG. 5 is a schematic flow chart diagram illustrating one embodiment of an I/O data access method in accordance with the present invention;

FIGS. 6a-6k are schematic block diagrams illustrating aspects of an exemplary expansion process of one embodiment of a non-redundant RAID set in accordance with the present invention;

FIGS. 7a-7f are schematic block diagrams illustrating aspects of an exemplary expansion process of one embodiment of a parity RAID set in accordance with the present invention;

FIG. 8 is a schematic block diagram illustrating aspects of an exemplary expansion of one embodiment of a mirrored RAID set in accordance with the present invention; and

FIG. 9 is a schematic block diagram illustrating aspects of an exemplary expansion of one embodiment of an alternate mirrored RAID set in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

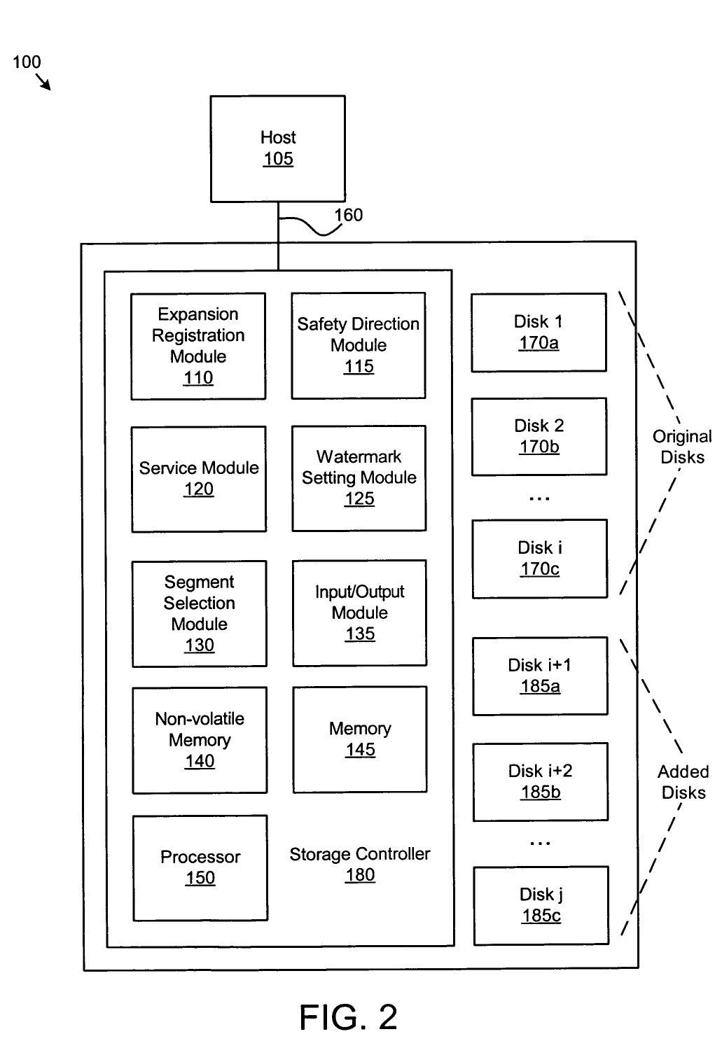

FIG. 2 is a schematic block diagram illustrating one embodiment of an online RAID set expansion system 100 in accordance with the present invention. The online RAID set expansion system 100 adds at least one disk to the existing source RAID set dynamically while assuring data integrity. The system 100 includes a host 105, a storage controller 180, one or more original disks 170, and one or more added disks 185, making the total number of disks equal j after an expansion. As used herein, i refers to the number of original disks 170 and j minus i (j−i) refers to the number of added disks for a total of j disks.

The storage controller 180 includes a processor 150, a memory 145, and a non-volatile memory 140, as generally known to those skilled in the art. Additionally, the storage controller 180 includes an expansion registration module 110, a safety direction module 115, a service module 120, a watermark setting module 125, a segment selection module 130, and a host interface 160. The host interface 160 couples the storage controller 180 to the host 105. In disclosed embodiments, the group of original disks 170 is used for configuration by the user as a RAID set of a certain level, referred to as a source RAID set, coupled to the storage controller 180. The original disk source RAID set may be expanded online to an added disk destination RAID set of the same RAID level. In one embodiment, the system 100 includes an input/output (“I/O”) module.

The expansion registration module 110 registers an expansion process in response to a host command and de-registers the expansion process upon the expansion process completion. The expansion process involves migration in an ascending numerical order of consecutively numbered data stripes from the source RAID set, to each stripe group of the destination RAID set in segments each consisting of one or more data stripes, including re-striping within the group. Based on a pre-specified formula, the safety direction module 115 identifies the number of stripe groups (or stripe group pairs for a mirrored RAID set) beginning with the first and lowest numbered stripe group in the destination RAID set forming a DZ, where certain data stripes may suffer a data loss in the event of a power failure during data migration because of overwriting of source data in the process. The safety direction module 115, therefore, determines a safe length of each segment to migrate within the DZ, to avoid such data loss altogether, and may further set a length of the segment to migrate beyond the DZ not only safely, but also with maximum efficiency inherent in the RAID set.

The watermark setting module 125 initializes a watermark before data migration begins, identifying data already in the first stripe group of the destination RAID set as inherited from the source RAID set. The segment selection module 130 addresses the data next in line to migrate in the segment based on the watermark and identifies the end of data migration. The service module 120 performs an expansion process on each selected segment with an appropriate length by copying data thereof from the source RAID set onto the destination RAID set. Subsequent to each segment migration, the watermark setting module 125 sets a watermark identifying data migrated. The I/O module manages I/O operations in concurrency with the online RAID set expansion process.

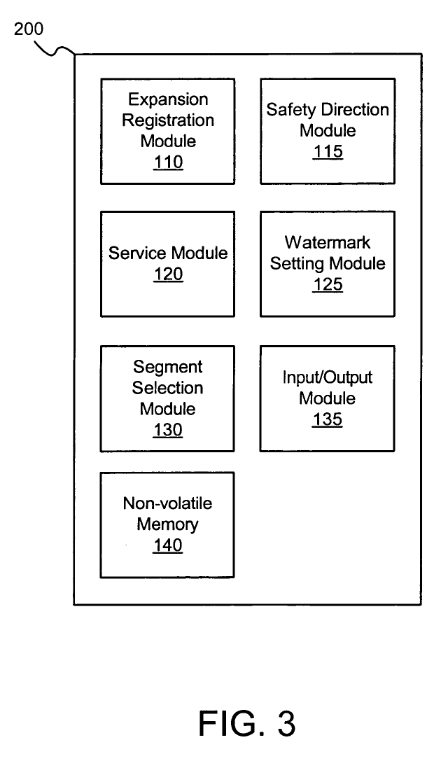

FIG. 3 is a schematic block diagram illustrating one embodiment of an online RAID set expansion apparatus 200 in accordance with the present invention. The apparatus 200 performs an online expansion from an i-disk RAID set to aj-disk destination RAID set with assurance of data integrity. The apparatus 200 includes an expansion registration module 110, a safety direction module 115, a service module 120, a watermark setting module 125, and a segment selection module 130. In one embodiment, the apparatus 200 also includes an I/O module 135.

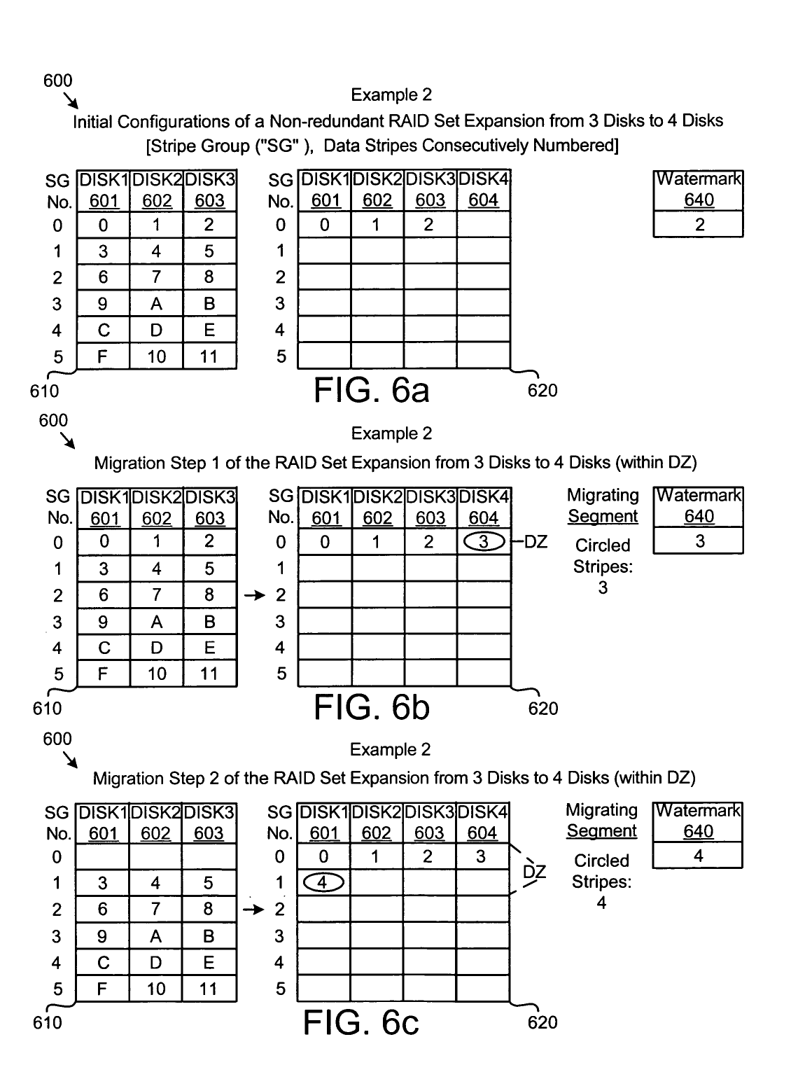

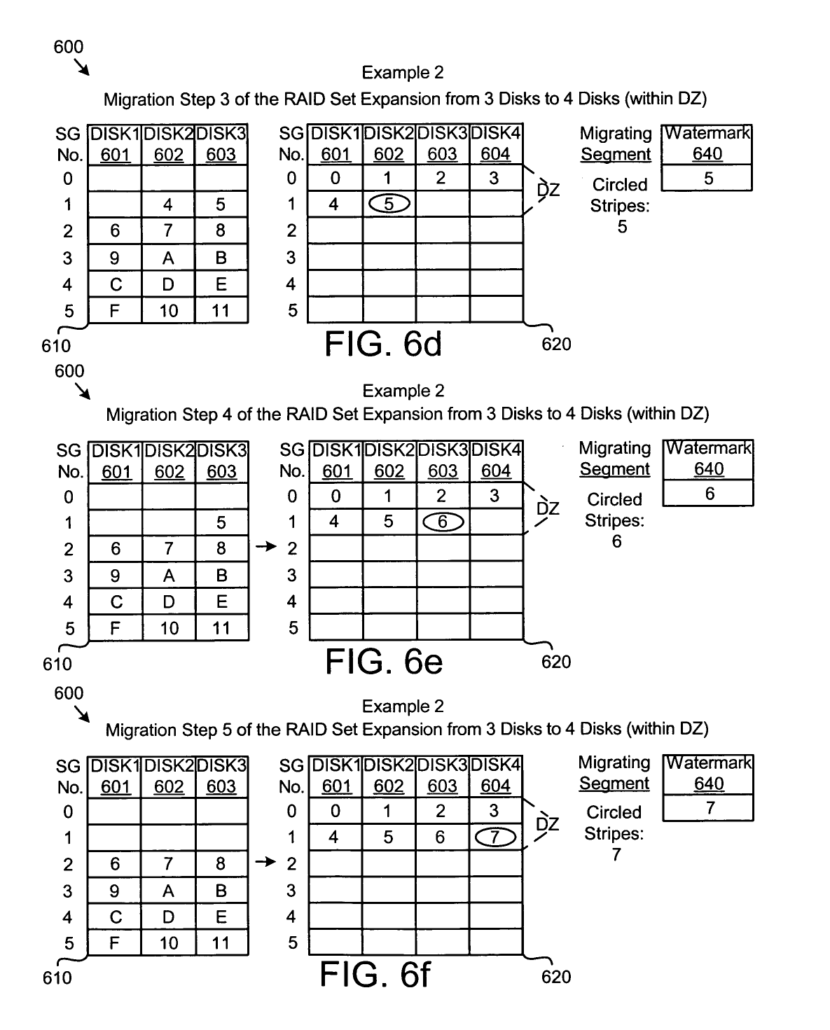

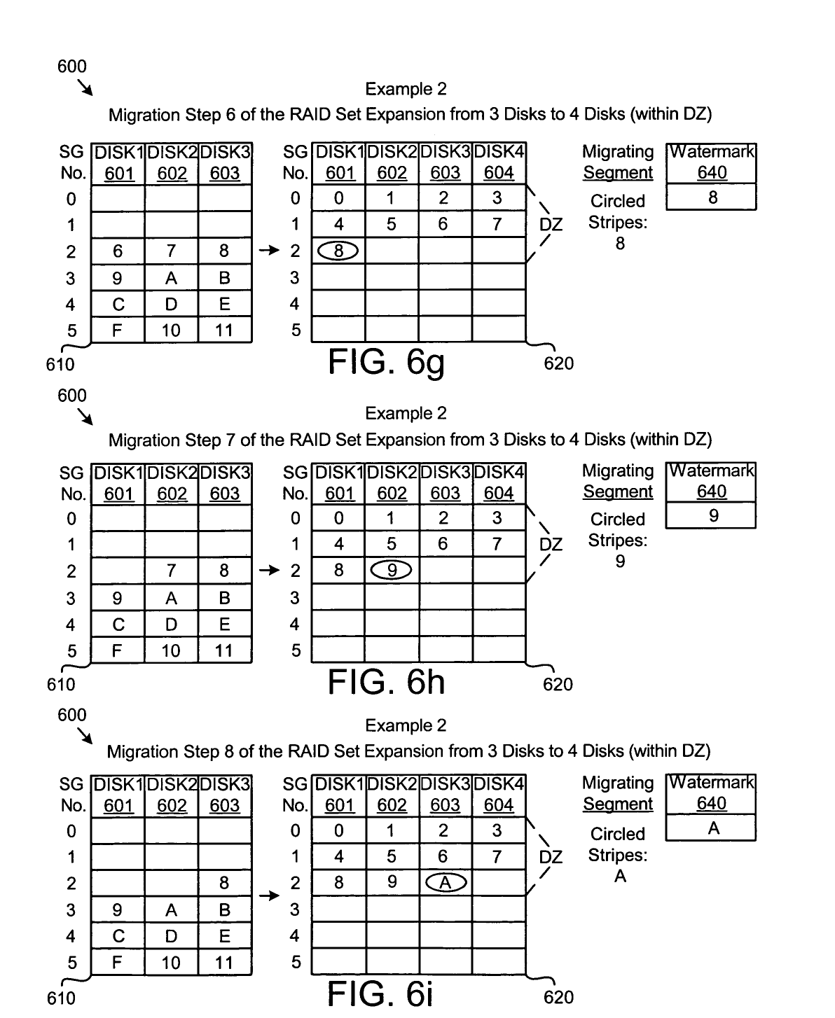

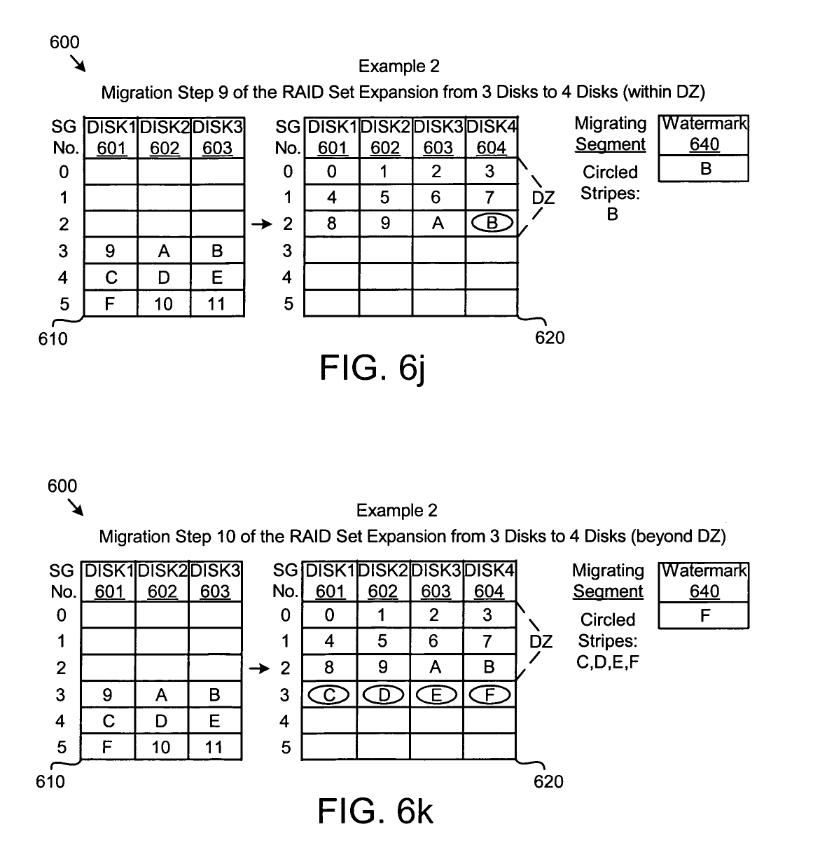

The expansion registration module 110 registers an expansion process responsive to a command issued by the host 105 and de-registers the expansion process upon completion. The expansion process calls for migrating in an ascending numerical order all consecutively numbered data stripes from the source RAID set, to each stripe group of the destination RAID set in segments, including re-striping within the group. The safety direction module 115 determines, based on a pre-specified formula for the type of RAID set to be expanded, the number of stripe groups (or stripe group pairs for a mirrored RAID set) beginning with the first and lowest numbered stripe group in the DZ in the destination RAID set. In order to avoid any data loss during migration due to a possible power failure, the safety direction module 115 divides each stripe group in the DZ into a plurality of sub-stripe groups as segments for migration, as shown in FIGS. 6b-6j. Thus, a safe length of the segment migrating within the DZ may be one data stripe, for example, which is migrated from one disk to another disk, avoiding overwriting of the source data. Beyond the DZ, the safety direction module 115 may set the segment length to include the whole stripe group in the destination RAID set for maximum migration efficiency as overwriting of source data is no longer possible as a result of data migration.

The watermark setting module 125 initializes a watermark identifying the highest numbered data stripe in the first stripe group of the destination RAID set before migration. In addition, the watermark setting module 125 sets a watermark identifying the highest numbered data stripe in each migrated segment after migration. Based on the watermark, the segment selection module 130 selects the next segment to migrate by addressing the data stripe numbered higher than the watermark by one (1). The segment selection module 130 also identifies the last segment to migrate from the source RAID set. The service module 120 performs an expansion process on each selected segment with the appropriate segment length by copying data thereof from the source RAID set to the destination RAID set. In one embodiment, the sub-stripe group configured for migration within the DZ includes at least one data stripe and at most j minus i (j−i) consecutive data stripes.

In certain embodiments, for an i-disk source RAID set to expand to a j-disk destination RAID set, the safety direction module 115 identifies the number of stripe groups (or stripe group pairs) in the DZ by use of a pre-specified formula for the type of RAID set undergoing an expansion. In general, the safety direction module 115 determines the number of stripe groups N in the DZ for a non-redundant RAID set by use of formula 1:
N equals i divided by the difference j minus i (N=i/(j−i)) rounded up to the next whole number. Formula 1

Similarly, the safety direction module determines the number of stripe group pairs P in the DZ for a mirrored RAID set by use of formula 2:
P equals i divided by the difference j minus i (P=i/(j−i)) rounded up to the next whole number. Formula 2

For a parity RAID set, the safety direction module determines the number of stripe group M in the DZ by use of formula 3:
M equals the difference i minus one divided by the difference j minus i (M=(i−1)/(j−i)) rounded up to the next whole number. Formula 3
In one embodiment, the sub-stripe group configured for migration within the DZ includes at least one data stripe and at most j minus i (j−i) consecutive data stripes.

By use of the above-mentioned formulas, for a destination RAID set having up to eight (8) disks for example, the number of stripe groups (or stripe group pairs for a mirrored RAID set) in the DZ of the destination RAID set in each case may be summarized in Table 1 below, based on the number of original disks i and the number of disks added to i to arrive at j total disks.

TABLE 1

| RAID | Source RAID | #Stripe Groups (or Pairs) in DZ for #Disks Added to get j: | | | | | |
|---|---|---|---|---|---|---|---|
| Type | Set #Disks i: | +1 | +2 | +3 | +4 | +5 | +6 |
| Non- | 2 | 2 | 1 | 1 | 1 | 1 | 1 |
| redundant | 3 | 3* | 2\hat{ } | 1 | 1 | 1 | |
| RAID Set | 4 | 4 | 2 | 2 | 1 | | |
| | 5 | 5 | 3 | 2 | | | |
| | 6 | 6 | 3 | | | | |
| | 7 | 7 | | | | | |
| Mirrored | 3 | 3 | 2 | 1 | 1 | 1 | |
| RAID Set | 4 | 4 | 2 | 2 | 1 | | |
| (e.g. | 5 | 5 | 3 | 2 | | | |
| RAID 6) | 6 | 6 | 3 | | | | |
| | 7 | 7 | | | | | |
| Parity | 3 | 2 | 1 | 1 | 1 | 1 | |
| RAID Set | 4 | 3 | 2 | 1 | 1 | | |
| | 5 | 4 | 2 | 2 | | | |
| | 6 | 5 | 3 | | | | |
| | 7 | 6 | | | | | |

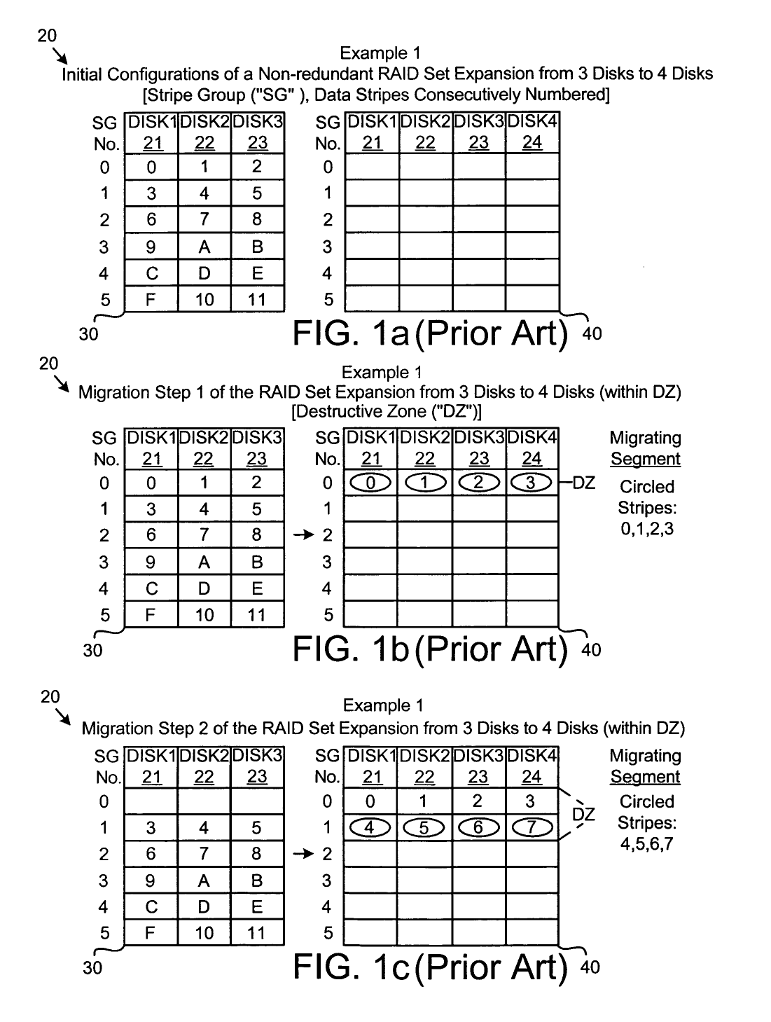

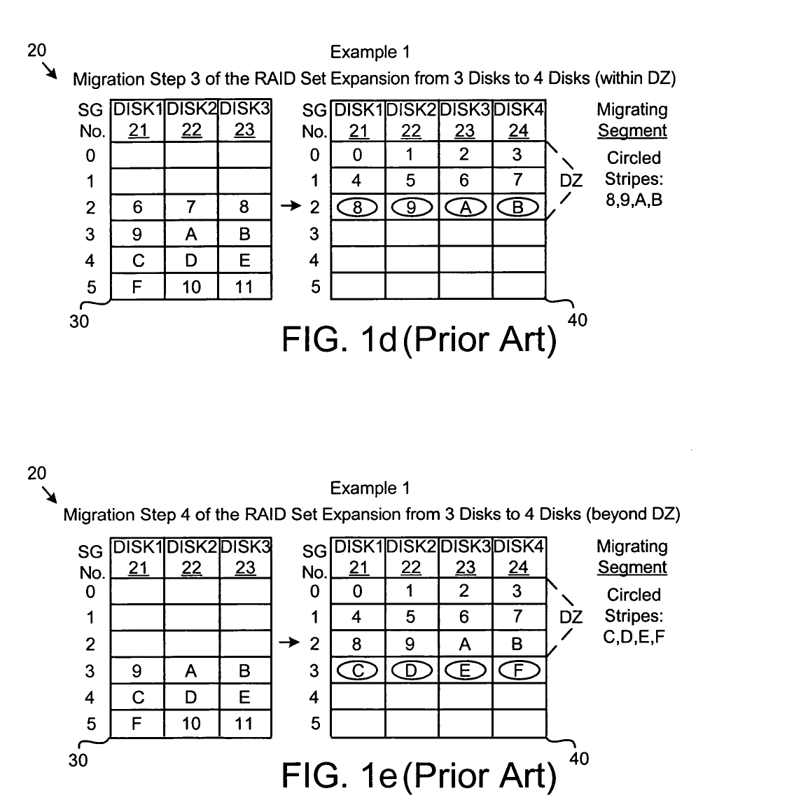

*Example 1: with i being equal to three (3) disks and one (1) disk added to i to arrive at j disks, where j equals four (4), the number of stripe groups in the DZ is three (3), which is determined by calculating (i/(j − i) = (3/(4 − 3)) = 3. Figures 1b through 1d illustrate the DZ.
\hat{ }Example 2: with i being equal to three (3) disks and two (2) disks added to i to arrive at j disks, where j equals five (5), the number of stripe groups in the DZ is 2, which is determined by calculating (i/(j − i)) = (3/(5 − 3)) = 1½ and rounding up the result to 2.

Two examples each with a non-redundant RAID set as described in the footnotes below may be used to illustrate how to read and arrive at Table 1 values.

In one embodiment, the apparatus 200 is configured to include a non-volatile memory 140, wherein the watermark is stored. In a certain embodiment, the apparatus 200 is further configured to include an I/O module 135. The I/O module 135 receives an I/O command to read or write data. The I/O command comprises a data block address which can be mapped to a data stripe, and is referred to herein as an associated data stripe, identifying where the data is to be read from or written to. If an expansion process is not active, the I/O module 135 accesses the data block as usual. If an expansion process is active, the I/O module 135 determines if the associated data stripe along with any stripe group check data is in transit for migration. If not so, the I/O module 135 accesses the data block. If any part of the data stripe along with any stripe group check data is in transit for migration, the I/O module delays accessing the data block. Furthermore, in one embodiment, if the associated data stripe of the addressed data block is below the watermark, the I/O module 135 may access the data block from the source RAID set. Otherwise, the I/O module 135 may access the data block from the destination RAID set.

The following schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbology employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

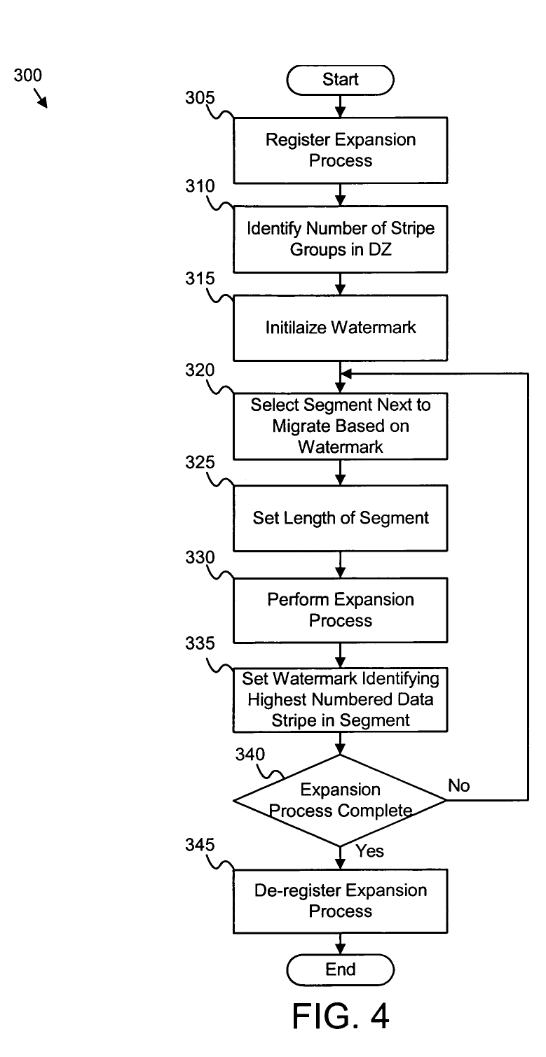

FIG. 4 is a schematic flow chart diagram illustrating one embodiment of an online RAID set expansion method 300 in accordance with the present invention. The expansion registration module 110 registers 305 an expansion process. The safety direction module 115 identifies 310 the number of stripe groups (or stripe group pairs) in the DZ in the destination RAID set by use of a pre-specified formula. In certain embodiments, for each type of RAID set undergoing an expansion, a particular formula is pre-specified factoring in the number of disks used in the destination RAID set and the number of disks used in the source RAID set, as described previously. The watermark setting module 125 initializes 315 a watermark identifying the highest numbered data stripe in the first stripe group of the destination RAID set that exists on an original disk prior to expansion.

To enable migrating consecutively numbered data stripes from the source RAID set to each stripe group in the destination RAID set in segments, the segment selection module 130 selects 320 a segment next to migrate based on the watermark established. The segment selection module 130 addresses the data stripe numbered higher than the data stripe identified by the watermark by one (1). The safety direction module 115 sets 325 the length of the segment next to migrate depending on whether the migration is within the DZ or beyond the DZ. If the migration is within the DZ, the segment includes a sub-stripe group containing, for example, one data stripe, to assure data integrity during migration because data is to be migrated from one disk to another disk, avoiding source data overwriting. If the migration is beyond the DZ, the segment may include the whole stripe group for migration efficiency.

The service module 120 performs 330 an expansion process on the segment selected by the segment selection module 130 with the appropriate length set by the safety direction module 115 by copying the segment data from the source RAID set onto the destination RAID set. Subsequent to the segment migration, the watermark setting module 125 sets 335 a watermark identifying the highest numbered data stripe in the migrated segment. The segment selection module 130 determines 340 if the expansion process is complete as indicated by the segment selection module 130. If the expansion process is complete, the expansion registration module 110 de-registers 345 the expansion process. If the expansion process is not complete, the segment selection module 130 selects 320 the segment next to migrate based on the watermark, and the rest of the process repeats for the segment migration.

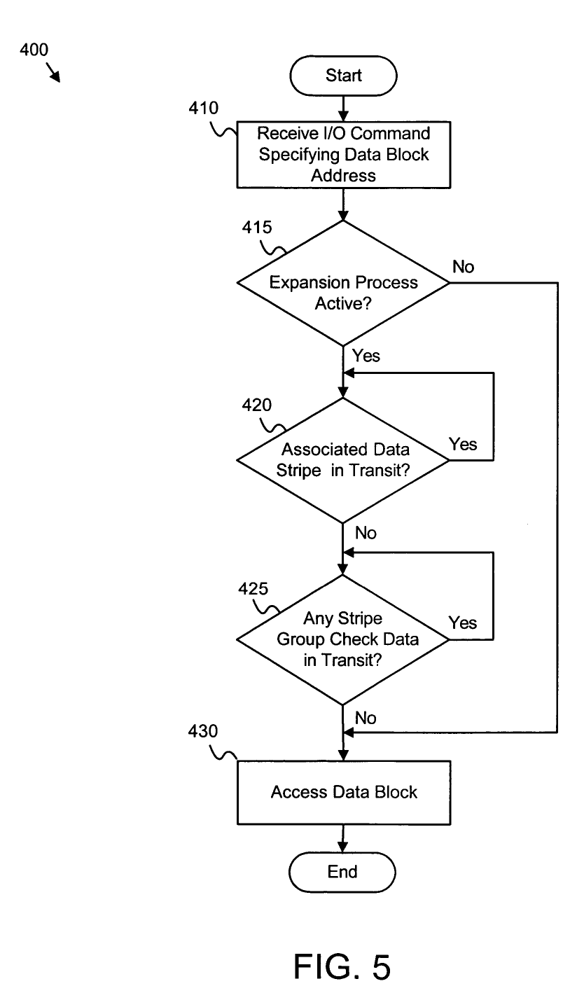

FIG. 5 is a schematic flow chart diagram illustrating of an I/O data access method 400 in accordance with the present invention. The I/O module 135 receives 410 an I/O command specifying a data block address from the host 105. The I/O module 135 determines 415 if an expansion process is active. In one embodiment, the I/O module 135 queries the expansion registration module 110 to determine 415 if an expansion process is active. If an expansion process is not active, the I/O module 135 accesses the data block addressed. If an expansion process is active, the I/O module 135 determines 420 if the associated data stripe including the addressed data block is in transit for migration. In one embodiment, the I/O module 135 queries the segment selection module 130 to determine 420 if the associated data stripe is in transit. If the associated data stripe is not in transit, the I/O module 135 determines 425 if any stripe group check data is in transit.

In one embodiment, the I/O module 135 queries the service module 120 to determine 425 if any stripe group check data is in transit. Any stripe group check data being in transit indicates that a check data stripe that may be required has not yet been placed in the appropriate stripe group of the destination RAID set during a re-striping within the group. If any stripe group check data is not in transit, the I/O module 135 accesses the data block addressed. If the associated data stripe is in transit, the I/O module 135 delays accessing the data block addressed. If any stripe group check data is in transit, the I/O module 135 delays accessing the data block addressed.

FIGS. 6a-6k are schematic block diagrams illustrating aspects of an exemplary expansion process 600 of one embodiment of a non-redundant RAID set in accordance with the present invention. In the process 600, data migration of a non-redundant RAID set expanding from three disks to four disks in various stages is shown in FIGS. 6a-6k FIG. 6a illustrates initial configurations of a 3-disk source RAID set 610 and a 4-disk destination RAID set 620 before data migration begins. As depicted, three data stripes numbered 0, 1, and 2 residing on disks 601, 602, and 603, respectively, already exist in the first stripe group of the destination RAID set 620. The watermark setting module 125 initializes a watermark 640 identifying the highest numbered data stripe in stripe group 0 of the destination RAID set 620, which is data stripe number 2.

Before data migration begins, the safety direction module 115 identifies the first three stripe groups in the would-be DZ had data migration been allowed to proceed as done in the prior art. Segment migrations throughout the DZ in various stages are shown in FIGS. 6b-6j. In accordance with the present invention, the safety direction module 115, therefore, sets a safe length of each segment to migrate throughout the DZ as including only one data stripe, to avoid any data loss due to a possible power failure because of the absence of corresponding source data overwriting. FIG. 6b shows that based on the watermark, data stripe number 3 is selected as the beginning data stripe of the segment next to migrate by the segment selection module 130 and migrated by the service module 120 to stripe group 0 of the destination RAID set 620. Subsequent to the segment migration, the watermark setting module 125 sets a new watermark identifying data stripe number 3 as the highest numbered data stripe migrated. Although stripe group 0 of the destination RAID set 620 is considered a part of the DZ, none of the data stripes therein are subject to data loss in the event of a power failure.

Likewise, FIGS. 6c-6j depict each single-stripe segment being migrated to the destination RAID set 620, with a watermark set subsequent to the migration. If a power loss occurs, for example, during the migration of data stripe number 4 to the destination RAID set 620 consisting of copying such stripe onto disk 1 601 in destination stripe group 1 as shown in FIG. 6c, data stripe number 4 in the source RAID set 610 is still available on disk 2 602 for re-migration after the power is restored.

Obviously, throughout the three-stripe group DZ, none of data stripes in migrating segments are losable due to a possible power outage because the corresponding source data is not being overwritten as each data stripe is migrated. As shown in FIG. 6k, beyond the DZ, data stripes number C, D, E, and F may be migrated to the destination RAID set in one segment, without data integrity exposure, as the corresponding source data stays intact throughout the segment migration. Subsequent to the segment migration, the watermark setting module 125 sets a watermark identifying data stripe numbered F as the highest numbered data stripe in the segment migrated. The next segment to migrate will include data stripe 10 and so on.

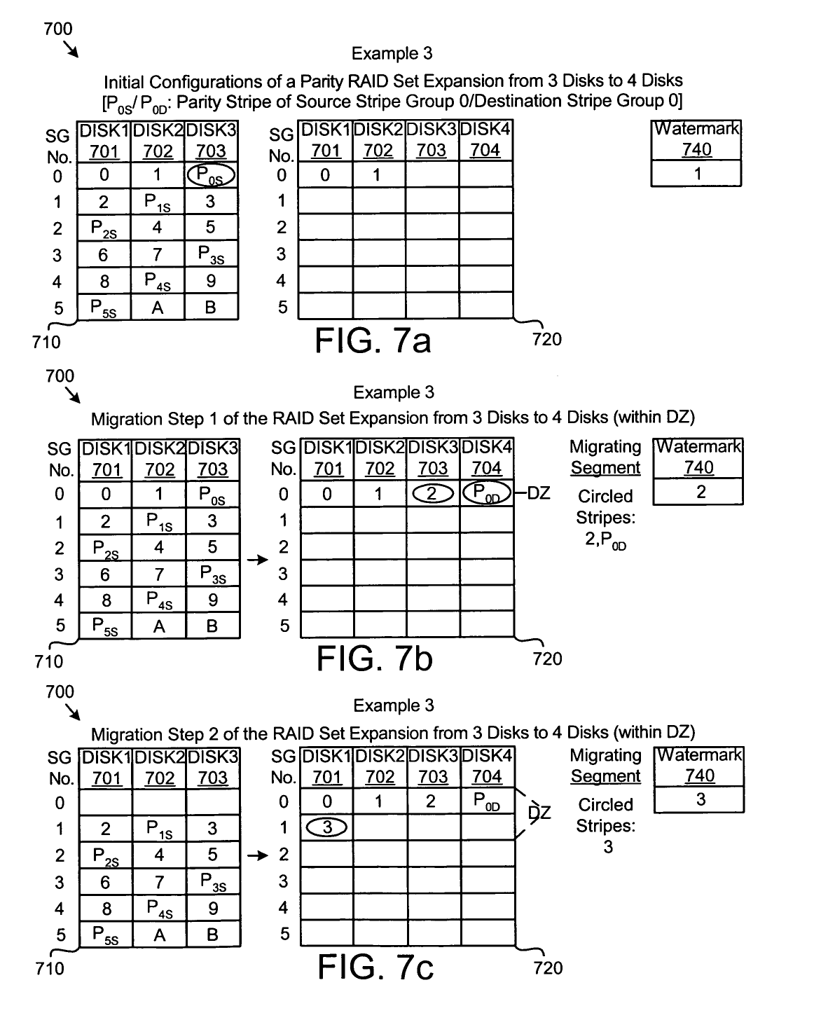

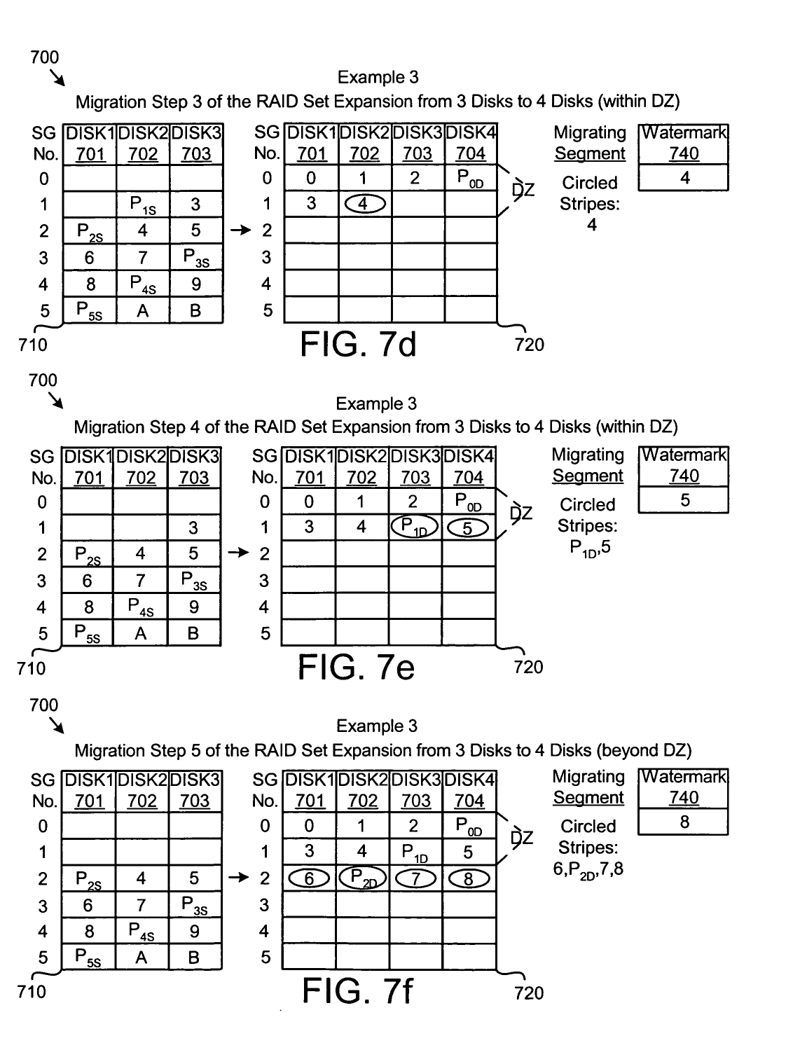

FIGS. 7a-7f are schematic block diagrams illustrating aspects of an exemplary expansion process 700 of one embodiment of a parity RAID set in accordance with the present invention. In the process 700, data migration of a parity RAID set expanding from three disks to four disks in various stages is shown. FIG. 7a illustrates initial configurations of a 3-disk source RAID set 710 and a 4-disk destination RAID set 720 before data migration begins. As depicted, two data stripes numbered 0 and 1 residing on disks 701 and 702, respectively, already exist in the first stripe group of the destination RAID set 720. The watermark setting module 125 initializes a watermark 740 identifying the highest numbered data stripe in stripe group 0 of the destination RAID set 720, which is data stripe number 1.

Before data migration begins, the safety direction module 115 identifies the first two stripe groups in the would-be DZ had data migration been allowed to proceed as done in the prior art. In accordance with the present invention, the safety direction module 115, therefore, sets a safe length of each segment to migrate throughout the DZ as including only one data stripe, to avoid any overwriting of source data leading to data loss due to a possible power failure. FIG. 7b shows that based on the watermark, data stripe number 2 is selected as the beginning data stripe of the segment next to migrate by the segment selection module 130 and is migrated by the service module 120 to stripe group 0 of the destination RAID set 720.

As the service module 120 recognizes that the RAID set undergoing an expansion is a parity RAID set, the service module 120 completes re-striping of stripe group 0 by generating a parity stripe P_{0D} as a result of performing exclusive or on all data including data stripes 0, 1, and 2 and migrating P_{0D} to disk 704 in stripe group 0. Subsequent to migration of the segment including data stripe 2 and parity stripe P_{0D}, the watermark setting module 125 sets a new watermark identifying data stripe number 2 migrated. Although stripe group 0 of the destination RAID set 620 is considered a part of the DZ, none of the data stripes therein are subject to data loss in the event of a power failure.

Likewise, FIGS. 7c-7e depict migration of each segment including a higher numbered single data stripe and a parity stripe as appropriate to stripe group 1 of the destination RAID set 720, with a watermark set accordingly subsequent to the migration. If, for example, during migration of data stripe number 3 consisting of copying data thereof to the destination RAID set 720 a shown in FIG. 7c, a power loss occurs. After the power is restored, data stripe number 3 in the source RAID set 710 is still available for re-migration.

Throughout the two-stripe group DZ, none of data stripes in migrating segments are losable due to possible a power outage because the corresponding source data is not being overwritten as each data stripe is migrated. As illustrated in FIG. 7f, beyond the DZ, data stripes numbered 6, P_{2D}, 7, and 8 may be migrated to the destination RAID set in one segment, without data integrity exposure, as the corresponding source data of the segment stays intact throughout the segment migration. Subsequent to the segment migration, the watermark setting module 125 sets a watermark identifying data stripe number 8 as the highest numbered data stripe in the segment migrated. The next segment to migrate will include data stripe 9 and so on.

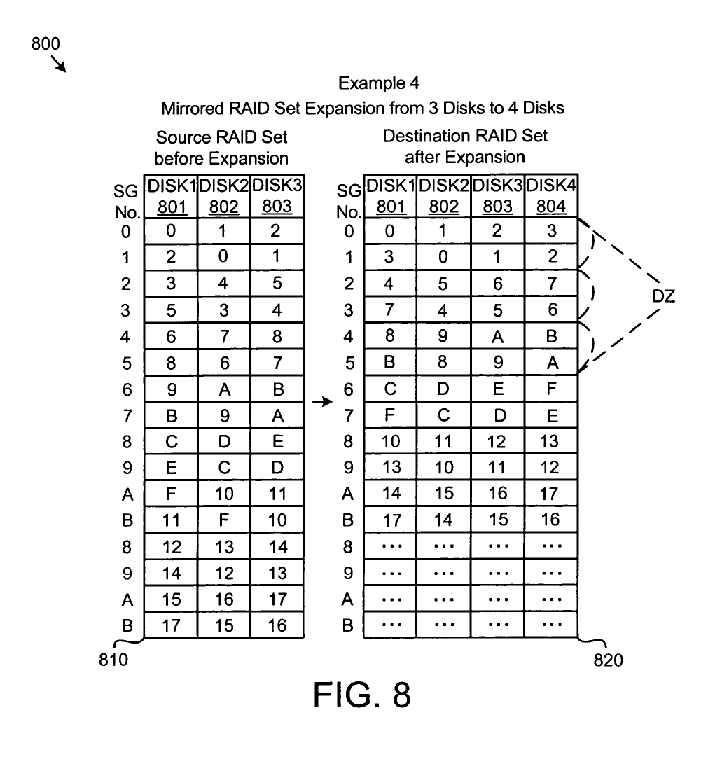

FIG. 8 is a schematic block diagram illustrating aspects of an exemplary expansion 800 of one embodiment of a mirrored RAID set in accordance with the present invention. As depicted, a 3-disk mirrored source RAID set 810 has been expanded to a 4-disk mirrored destination RAID set 820. The safety direction module 115 had identified three stripe group pairs: stripe groups 0 and 1, stripe groups 2 and 3, and stripe groups 4 and 5, in the DZ of the destination RAID set 820, as indicated. Migration within the DZ involves segments including a single data stripe each, assuring data integrity during segment migration. Beyond the DZ, each segment including 4 consecutive data stripes each may be safely migrated to each stripe group of the destination RAID set 820 in succession as conducted in prior art for efficiency.

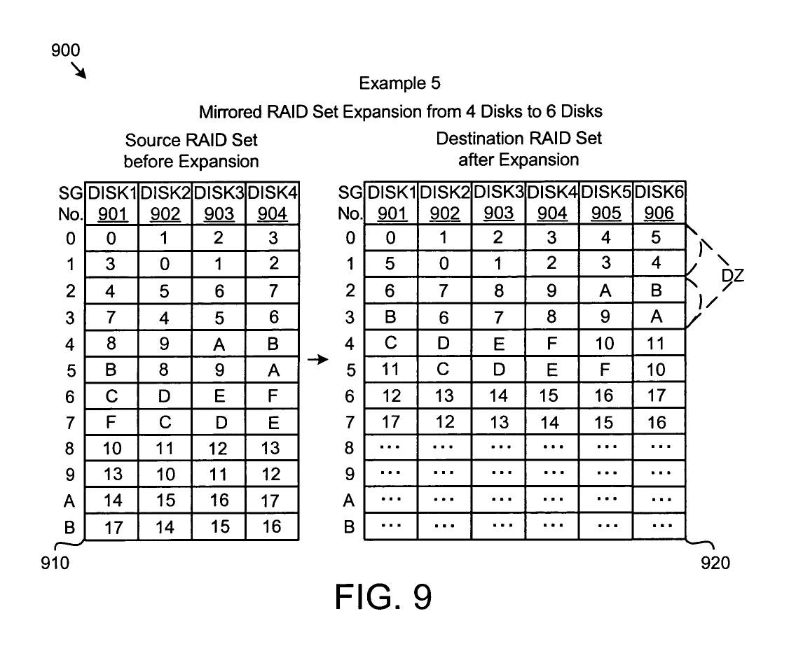

FIG. 9 is a schematic block diagram illustrating aspects of an exemplary expansion 900 of one embodiment of an alternate mirrored RAID set in accordance with the present invention. In the depicted embodiment, a 4-disk mirrored source RAID set 910 has been expanded to a 6-disk mirrored destination RAID set 920. The safety direction module 115 had identified two stripe group pairs: stripe groups 0 and 1 and stripe groups 2 and 3, in the DZ of the destination RAID set 920, as indicated. In one embodiment, migration within the DZ may involve segments including two (2) data stripes each, still assuring data integrity during segment migration. Beyond the DZ, each segment including six (6) consecutive data stripes each may be safely migrated to each stripe group of the destination RAID set 920 in succession as conducted in prior art for efficiency.

The present invention determines a safe length for each segment migrating to the DZ, avoiding any loss of data due to a possible power failure without requiring a backup of any data prior to migration. In addition, the present invention allows data migration in segments to proceed beyond the DZ with a different length so as to achieve a maximum efficiency, as possible in the prior art. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to expand online a disk source RAID set having an amount i of disks to a disk destination RAID set having an amount of disks j, where j is greater than i, the apparatus comprising:
an expansion registration module configured to register an expansion process responsive to a host command and further configured to de-register the completed expansion process;
a safety direction module configured to identify based on a pre-specified formula the number of stripe groups beginning with the first and lowest numbered stripe group in a destructive zone (DZ) in the destination RAID set, and further configured to set for each stripe group in the destination RAID set a safe length of a segment for data migration, the safe length of the segment comprising a sub-stripe group within the DZ and comprising a whole stripe group beyond the DZ;
a service module configured to perform the expansion process on a plurality of segments, the expansion process configured to migrate in an ascending numerical order consecutive data stripes by copying data thereof from the source RAID set to each stripe group of the destination RAID set in segments including re-striping within the group and further configured to obtain the length of each segment for data migration from the safety direction module;
a watermark setting module configured to set a watermark identifying the highest numbered data stripe placed in the destination RAID set for the first stripe group in the initial pre-migration configuration and for each post-segment migration configuration; and
a segment selection module configured to address the next higher numbered data stripe responsive to the watermark for a segment migration by the service module and further configured to identify the last segment for migration.

2. The apparatus of claim 1, wherein each stripe group for a parity RAID array in the destination RAID set comprises a stripe of check data in addition to j minus one (j−1) data stripes.

3. The apparatus of claim 1, further comprising an I/O module configured to receive an I/O command specifying a data block address, access the data block if the associated data stripe along with any stripe group check data is not in transit for migration, and delay the access of the data block if any part of the associated data stripe along with any stripe group check data is in transit for migration.

4. The apparatus of claim 3, wherein the I/O command is configured to access the addressed data block from the source RAID set if the associated data stripe is below the watermark.

5. The apparatus of claim 3, wherein the I/O command is configured to access the addressed data block from the destination RAID set if the associated data stripe is not below the watermark.

6. The apparatus of claim 1, wherein the safety direction module determines the number of stripe groups N in the DZ for a non-redundant RAID by use of the formula:
N equals i divided by the difference j minus i (N=i/(j−i)) rounded up to the next whole number.

7. The apparatus of claim 1, wherein the safety direction module determines the number of stripe group pairs P in the DZ for a mirrored RAID set by use of the formula:
P equals i divided by the difference j minus i (P=i/(j−i)) rounded up to the next whole number.

8. The apparatus of claim 1, wherein the safety direction module determines the number of stripe groups M in the DZ for a parity RAID set by use of the formula:
M equals the difference i minus one divided by the difference j minus i (M=(i−1)/(j−i)) rounded up to the next whole number.

9. The apparatus of claim 1, wherein the sub-stripe group configured for migration within the DZ comprises at least one data stripe and at most j minus i (j−i) consecutive data stripes.

10. The apparatus of claim 1, wherein the watermark is configured to be stored in a non-volatile memory.

11. A system to expand online a disk source RAID set having an amount i of disks to a disk destination RAID set having an amount of disks j, where j is greater than i, the system comprising:
a host;
an amount of disks j; and
a storage controller, coupled to the j disks, the storage controller comprising:
a processor;
a memory coupled to the processor;
a non-volatile memory coupled to the processor;
a host interface coupling the controller to the host;
an expansion registration module configured to register an expansion process responsive to a host command and is further configured to de-register the completed expansion process;
a safety direction module configured to identify based on a pre-specified formula the number of stripe groups beginning with the first and lowest numbered stripe group in a DZ in the destination RAID set, and further configured to set for each stripe group in the destination RAID set a safe length of a segment for data migration, the safe length of the segment comprising a sub-stripe group within the DZ and comprising a whole stripe group beyond the DZ;
a service module configured to perform the expansion process on a plurality of data segments, the expansion process configured to migrate in an ascending numerical order consecutive data stripes by copying data thereof from the source RAID set to each stripe group of the destination RAID set in segments including re-striping within the group and further configured to obtain the length of each segment for data migration from the safety direction module;
a watermark setting module configured to set a watermark identifying the highest numbered data stripe placed in the destination RAID set for the first stripe group in the initial pre-migration configuration and for each post-segmnent migration configuration; and
a segment selection module configured to address the next higher numbered data stripe based on the watermark for a segment migration by the service module and further configured to identify the last segment for migration.

12. The system of claim 11, wherein each stripe group for a parity RAID array in the destination RAID set comprises a stripe of check data in addition to j minus one (j−1) data stripes.

13. The system of claim 11, further comprising an I/O module configured to receive an I/O command specifying a data block address, access the data block if the associated data stripe along with any stripe group check data is not in transit for migration, and delay the access of the data block if any part of the associated data stripe along with any stripe group check data is in transit for migration.

14. The system of claim 13, wherein the I/O command is configured to access the addressed data block from the source RAID set if the associated data stripe is below the watermark.

15. The system of claim 13, wherein the I/O command is configured to access the addressed data block from the destination RAID set if the associated data stripe is not below the watermark.

16. The system of claim 11, wherein the safety direction module determines the number of stripe groups N in the DZ for a non-redundant RAID set by use of the formula:
N equals i divided by the difference j minus i (N=i/(j−i)) rounded up to the next whole number.

17. The system of claim 11, wherein the safety direction module determines the number of stripe group pairs P in the DZ for a mirrored RAID set by use of the formula:
P equals i divided by the difference j minus i (P=i/(j−i)) rounded up to the next whole number.

18. The system of claim 11, wherein the safety direction module determines the number of stripe groups M in the DZ for a parity RAID set by use of the formula:
M equals the difference i minus one divided by the difference j minus i (M=(i−1)/(j−i)) rounded up to the next whole number.

19. The system of claim 11, wherein the sub-stripe group configured for migration within the DZ comprises at least one data stripe and at most j minus i (j−i) consecutive data stripes.

20. The system of claim 11, wherein the watermark is configured to be stored in a non-volatile memory.

21. The system of claim 11, wherein the disks in a RAID set are selected from hard disk drives, optical disks, magneto-optical disks, solid state disks, magnetic tape drives, DVD disks, and CD-ROM disks.

22. A signal bearing medium tangibly embodying a program of machine-readable instructions executable by a digital processing apparatus to perform operations to expand online a disk source RAID set having an amount i of disks to a disk destination RAID set having an amount of disks j, where j is greater than i, the operations comprising:
registering an expansion process configured to service a host, the expansion process comprising migration in ascending numerical order of consecutive data stripes by copying data thereof from the source RAID set to each stripe group of the destination RAID set in segments including re-striping within the group, the length of each segment within the DZ comprising a sub-stripe group and the length of each segment beyond the DZ comprising a whole stripe group;
identifying the number of stripe groups in the DZ in the destination RAID set;
initializing a watermark identifying the highest numbered data stripe already in the first stripe group of the destination RAID set;
selecting a segment next to migrate based on the watermark;
setting the length of the segment next to migrate according to the destination position;
performing the expansion process on each selected segment with the indicated length;
setting a watermark identifying the highest numbered data stripe in the segment migrated; and
de-registering the expansion process upon completion.

23. The signal bearing medium of claim 22, wherein the instructions further comprise operations to compute check data comprised in each stripe group of a parity RAID array in the destination RAID set.

24. The signal bearing medium of claim 22, wherein the instructions further comprise operations to receive an I/O command specifying a data block address, access the data block if the associated data stripe along with any stripe group check data is not in transit for migration, and delay the access of the data block if any part of the associated data stripe along with any stripe group check data is in transit for migration.

25. The signal bearing medium of claim 24, wherein the instructions further comprise operations to direct the I/O command being executed to access the addressed data block from the source RAID set if the associated data stripe is below the watermark.

26. The signal bearing medium of claim 24, wherein the instructions further comprise operations to direct the I/O command being executed to access the addressed data block from the destination RAID set if the associated data stripe is not below the watermark.

27. The signal bearing medium of claim 22, wherein the instructions further comprise operations to determine the number of stripe groups N in the DZ for a non-redundant RAID set by use of the formula:
N equals i divided by the difference j minus i (N=i/(j−i)) rounded up to the next whole number.

28. The signal bearing medium of claim 22, wherein the instructions further comprise operations to determine the number of stripe group pairs P in the DZ for a mirrored RAID set by use of the formula:
P equals i divided by the difference j minus i (P=i/(j−i)) rounded up to the next whole number.

29. The signal bearing medium of claim 22, wherein the instructions further comprise operations to determine the number of stripe groups M in the DZ for a parity RAID set by use of the formula:
M equals the difference i minus one divided by the difference j minus I (M=(i−1)/(j−i)) rounded up to the next whole number.

30. The signal bearing medium of claim 22, wherein the instructions further comprise operations to specify the size of the sub-stripe group for migration to the DZ as one data stripe at least and j minus i (j−i) data stripes at most.

31. A method for expanding online a disk source RAID set having an amount i of disks to a disk destination RAID set having an amount of disks j, where j is greater than i, the method comprising:
registering an expansion process configured to service a host, the expansion process comprising migration in ascending numerical order of consecutive data stripes by copying data thereof from the source RAID set to each stripe group of the destination RAID set in segments including re-striping within the group, the length of each segment within the DZ comprising a sub-stripe group and the length of each segment beyond the DZ comprising a whole stripe group;
identifying the number of stripe groups in the DZ in the destination RAID set;
initializing a watermark identifying the highest numbered data stripe already in the first stripe group of the destination RAID set;
selecting a segment next to migrate based on the watermark;
setting the length of the segment next to migrate according the destination position;
performing the expansion process on each selected segment with the indicated length;
setting a watermark identifying the highest numbered data stripe in the segment migrated; and
de-registering the expansion process upon completion.
